(19) United States
(12) Patent Application Publication
(10) Pub. No.: US 2025/0276537 A1
(43) Pub. Date: Sep. 4, 2025

(54) RECORDING DEVICE

(71) Applicant: SEIKO EPSON CORPORATION, Tokyo (JP)

(72) Inventor: Keisuke SASAKI, MATSUMOTO-SHI (JP)

(21) Appl. No.: 19/063,654

(22) Filed: Feb. 26, 2025

(30) Foreign Application Priority Data
Feb. 29, 2024 (JP) 2024-029620

(51) Int. Cl. B41J 11/58; B41J 2/175; B65H 1/26

(52) U.S. Cl. CPC B41J 11/58; B41J 2/17566; B65H 1/266; B41J 2002/17573; B65H 2402/32

(57) ABSTRACT

A recording device includes a recording unit that performs recording on a medium, a device main body that accommodates the recording unit, a medium accommodation unit, and a placement unit covering at least a portion of the medium accommodation unit. The medium accommodation unit is displaceable between a pulled-out state in which the medium accommodation unit is pulled out from the device maim body and an accommodated state in which the medium accommodation unit is accommodated in the device main body, and is not removable from the device main body. The placement unit is displaceable between a protruding state in which the placement unit protrudes from the device main body and a retracted state in which the placement unit is retracted from the protruding state. At least a portion of the placement unit transmits light to cause at least a portion of the medium accommodation unit to be visible.

The present application is based on, and claims priority from JP Application Serial Number 2024-029620, filed Feb. 29, 2024, the disclosure of which is hereby incorporated by reference herein in its entirety.

### BACKGROUND

### 1. Technical Field

The present disclosure relates to a recording device that performs recording on a medium.

### 2. Related Art

An inkjet recording device disclosed in JP-A-2006-327802 includes a paper discharge tray above a paper feed cassette. The paper discharge tray is provided such that a protrusion amount of the paper discharge tray from the front surface of the device can be switched.

When a user attempts to accommodate sheets in the paper feed cassette in a state in which the paper discharge tray protrudes from the front surface of the device, it is difficult for the user to accommodate the sheets because the paper discharge tray is covering the paper feed cassette. In particular, in a configuration in which the paper feed cassette is not removable, since it is necessary to retract the paper discharge tray in order to easily accommodate the sheets, the operation becomes troublesome.

### SUMMARY

In order to solve the problem described above, a recording device according to the present disclosure includes a recording unit configured to perform recording on a medium, a device main body configured to accommodate the recording unit, a medium accommodation unit configured to accommodate the medium to be recorded by the recording unit, and a placement unit covering at least a portion of the medium accommodation unit from above the medium accommodation unit and on which the medium recorded by the recording unit is placed. The medium accommodation unit is displaceable between a pulled-out state in which the medium accommodation unit is pulled out from the device main body and an accommodated state in which the medium accommodation unit is accommodated in the device main body, and is not removable from the device main body. The placement unit is displaceable between a protruding state in which the placement unit protrudes from the device main body and a retracted state in which the placement unit is retracted from the protruding state, and at least a portion of the placement unit transmits light to cause at least a portion of the medium accommodation unit to be visible.

### BRIEF DESCRIPTION OF THE DRAWINGS

FIG. 1 is a perspective view of a printer in a state in which a cover unit is closed.

FIG. 2 is a perspective view of the printer when the cover unit is open, a placement unit is in a retracted state, and a medium accommodation unit is in an accommodated state.

FIG. 3 is a perspective view of the printer when the cover unit is open, the placement unit is in a protruding state, and the medium accommodation unit is in the accommodated state.

FIG. 4 is a perspective view of the printer when the cover unit is open, the placement unit is in the protruding state, and the medium accommodation unit is in a pulled-out state.

FIG. 5 is a perspective view of the printer when the cover unit is open, the placement unit is in the protruding state, and the medium accommodation unit is in the pulled-out state.

FIG. 6 is a plan view of the placement unit when the cover unit is open, the placement unit is in the protruding state, and the medium accommodation unit is in the pulled-out state.

FIG. 7 is a plan view of a modified example of the placement unit when the cover unit is open, the placement unit is in the protruding state, and the medium accommodation unit is in the pulled-out state.

### DESCRIPTION OF EMBODIMENTS

Hereinafter, the present disclosure will be described in brief.

A recording device according to a first aspect includes a recording unit configured to perform recording on a medium, a device main body configured to accommodate the recording unit, a medium accommodation unit configured to accommodate the medium to be recorded by the recording unit, and a placement unit covering at least a portion of the medium accommodation unit from above the medium accommodation unit and on which the medium recorded by the recording unit is placed. The medium accommodation unit is displaceable between a pulled-out state in which the medium accommodation unit is pulled out from the device main body and an accommodated state in which the medium accommodation unit is accommodated in the device main body, and is not removable from the device main body. The placement unit is displaceable between a protruding state in which the placement unit protrudes from the device main body and a retracted state in which the placement unit is retracted from the protruding state, and at least a portion of the placement unit transmits light to cause at least a portion of the medium accommodation unit to be visible.

In a configuration in which the medium accommodation unit is not removable from the device main body and the placement unit is disposed above the medium accommodation unit, when storing the medium in the medium accommodation unit, the medium accommodation unit may not be visible due to the placement unit and it may be difficult to accommodate the medium in the medium accommodation unit.

However, according to the first aspect, since at least the portion of the placement unit transmits light to cause at least the portion of the medium accommodation unit to be visible, it becomes easier to accommodate the medium in the medium accommodation unit.

In a second aspect, which is an aspect subordinate to the first aspect, when viewed in a direction intersecting a placement surface of the placement unit, at least a portion of the placement unit in the protruding state overlaps the medium accommodation unit in the pulled-out state, and the overlapping portion transmits light.

In a configuration in which the placement unit in the protruding state overlaps the medium accommodation unit in the pulled-out state, when storing the medium in the medium accommodation unit, the medium accommodation unit may not be visible due to the placement unit and it may be difficult to accommodate the medium in the medium accommodation unit.

However, since at least the portion of the placement unit in the protruding state overlaps the medium accommodation unit in the pulled-out state and the overlapping portion transmits light, it becomes easier to accommodate the medium in the medium accommodation unit.

In a third aspect, which is an aspect subordinate to the first aspect, the medium accommodation unit includes a regulating unit configured to regulate an end portion of the medium, and when viewed in a direction intersecting a placement surface of the placement unit, a portion, of the placement unit in the protruding state, overlapping the regulating unit of the medium accommodation unit in the pulled-out state transmits light.

In a configuration in which the medium accommodation unit includes the regulating unit that regulates the end portion of the medium, when storing the medium in the medium accommodation unit, the medium is easily caught by the regulating unit.

However, according to the third aspect, since, when viewed in the direction intersecting the placement surface of the placement unit, the portion, of the placement unit in the protruding state, overlapping the regulating unit of the medium accommodation unit in the pulled-out state transmits light, the regulating unit is visible even when the placement unit is in the protruding state. Accordingly, when storing the medium in the medium accommodation unit, the medium is less likely to be caught by the regulating unit, and it becomes easier to accommodate the medium.

This aspect is not limited to the first aspect, and may be subordinate to the second aspect.

In a fourth aspect, which is an aspect subordinate to the first aspect, a whole of the placement unit transmits light.

According to the fourth aspect, since the whole of the placement unit transmits light, a wide range of the medium accommodation unit becomes easily visible.

In a fifth aspect, which is an aspect subordinate to the fourth aspect, the recording unit performs recording by ejecting a liquid onto the medium, the device main body includes a liquid storage unit configured to store the liquid to be ejected by the recording unit, and a viewing unit configured to make visible a remaining amount of the liquid in the liquid storage unit, and the viewing unit overlaps the placement unit in a device height direction.

According to the fifth aspect, since the viewing unit overlaps the placement unit in the device height direction, there is a risk that the placement unit overlaps the viewing unit and obstructs viewing of the viewing unit. However, due to the effect of the fourth aspect described above, the viewing unit becomes visible through the placement unit.

In a sixth aspect, which is an aspect subordinate to any one of the first to fifth aspects, the device main body is formed with a pull-out port through which the medium accommodation unit is pulled out, and the medium accommodation unit includes a stacking unit on which the medium is stacked, the stacking unit having an opening in a pull-out direction of the medium accommodation unit from the device main body, and a cover unit provided at one end of the stacking unit in the pull-out direction and configured to be displaceable between a closed state, in which the cover unit closes the pull-out port and the opening in a posture intersecting the stacking unit, and an open state, in which the cover unit opens the pull-out port and the opening.

In a configuration in which the stacking unit has the opening in the pull-out direction of the medium accommodation unit from the device main body and the cover unit opens and closes the pull-out port of the device main body and the opening of the stacking unit, when the cover unit is open, some users may attempt to accommodate the medium from the opening of the stacking unit in a state in which the placement unit is in the protruding state. At this time, the medium accommodation unit may not be visible due to the placement unit and it may be difficult to accommodate the medium in the medium accommodation unit. However, due to the effect of the first aspect described above, it becomes easier to accommodate the medium in the medium accommodation unit.

In a seventh aspect, which is an aspect subordinate to any one of the first to fifth aspects, in a width direction that is a direction intersecting a displacement direction of the medium accommodation unit and the placement unit, a dimension of the placement unit is larger than a dimension of the medium accommodation unit.

In a configuration in which the dimension of the placement unit is larger than the dimension of the medium accommodation unit in the width direction, the medium accommodation unit becomes even less visible due to the placement unit. However, since at least the portion of the medium accommodation unit becomes visible due to the effect of the first aspect described above, it becomes easier to accommodate the medium in the medium accommodation unit.

This aspect is not limited to any one of the first to fifth aspects, and may be subordinate to the sixth aspect.

In an eighth aspect, which is an aspect subordinate to any one of the first to fifth aspects, in a displacement direction of the medium accommodation unit and the placement unit, a front end of the placement unit in the retracted state is aligned with a front end of the medium accommodation unit in the accommodated state.

According to the eighth aspect, since, in the displacement direction of the medium accommodation unit and the placement unit, the front end of the placement unit in the retracted state is aligned with the front end of the medium accommodation unit in the accommodated state, the placement unit can suppress dust and the like from entering the interior of the medium accommodation unit. On the other hand, the medium accommodation unit is hidden by the placement unit. However, since at least the portion of the medium accommodation unit becomes visible due to the effect of the first aspect described above, it becomes easier to accommodate the medium in the medium accommodation unit.

This aspect is not limited to any one of the first to fifth aspects, and may be subordinate to the sixth or seventh aspect.

In a ninth aspect, which is an aspect subordinate to any one of the first to fifth aspects, the placement unit is power driven to be displaced between the protruding state and the retracted state using power.

According to the ninth aspect, since the placement unit is power driven to be displaced between the protruding state and the retracted state using power, the placement unit 23 automatically enters the protruding state when the medium is discharged, and it is thus possible to prevent the user from forgetting to perform the operation. On the other hand, as a result of the placement unit automatically entering the protruding state, there is a risk that the medium accommodation unit becomes less visible due to the placement unit. However, since at least the portion of the medium accommodation unit becomes visible due to the effect of the first aspect described above, it becomes easier to accommodate the medium in the medium accommodation unit.

Hereinafter, the present disclosure will be described in detail.

Note that, in each diagram, an X-axis direction is a device width direction, a −X direction is a right direction as viewed from a user when a device front surface faces the user, and a +X direction is a left direction as viewed from the user. A Y-axis direction is a device depth direction, a +Y direction is a direction from a device rear surface to the device front surface, and a −Y direction is a direction from the device front surface to the device rear surface. Note that, in this embodiment, among device side surfaces, a surface at which an operating panel 15 is provided, that is, a side surface in the +Y direction of a device is the device front surface. Further, a Z-axis direction is the vertical direction, a +Z direction is a vertically upward direction, and a −Z direction is a vertically downward direction.

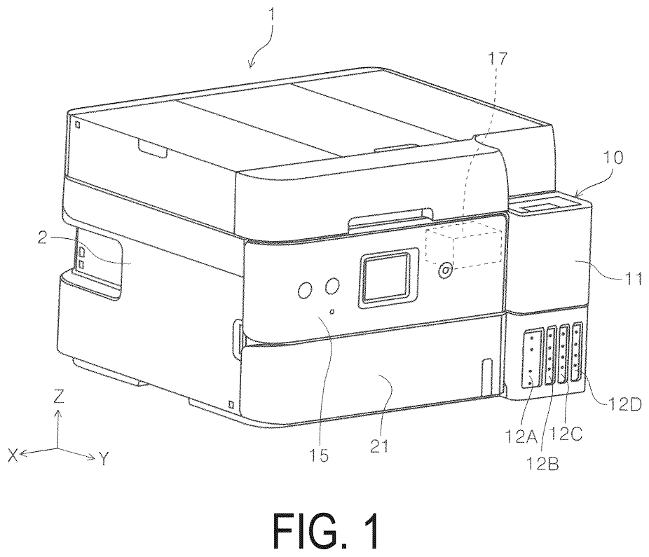

In FIGS. 1 to 4, an inkjet printer 1, which is an example of a recording device, includes a device main body 2. Hereinafter, the inkjet printer will be abbreviated as a “printer”. The device main body 2 has a box-like outer shape as a whole.

The device main body 2 has a function of performing recording on a medium represented by recording paper. The device main body 2 includes an ink ejecting head 17 that ejects ink onto the medium. The ink ejecting head 17 is provided at a carriage (not illustrated) that moves in the X-axis direction, that is, a medium width direction. Ink is supplied to the ink ejecting head 17 from a liquid storage unit 10 through an ink tube (not illustrated).

The operating panel 15 for performing various operation settings is provided at the device front surface.

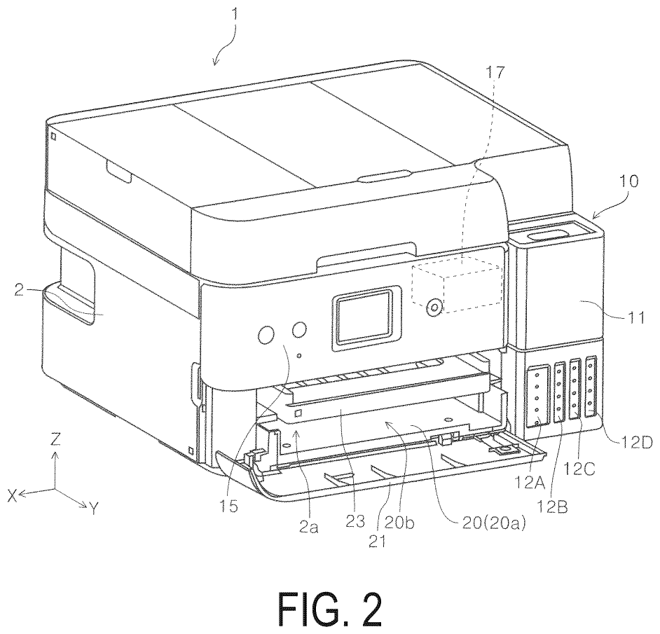

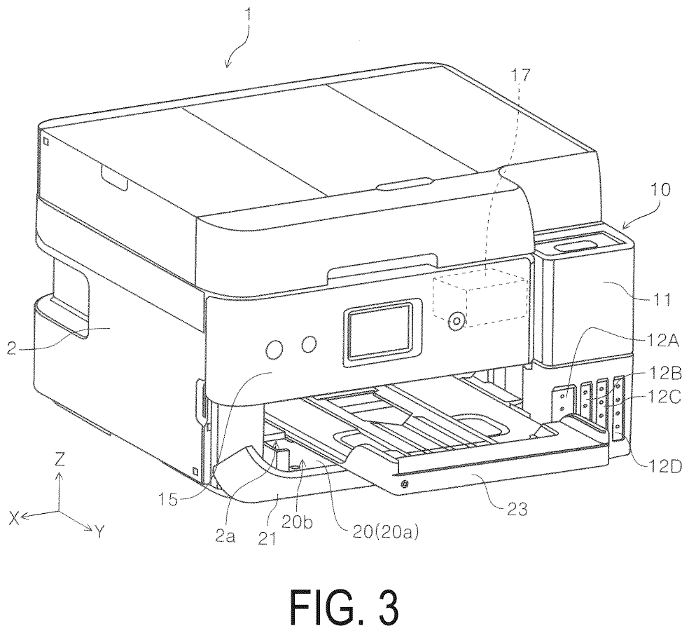

A cover unit 21 is provided below the operating panel 15. The cover unit 21 is provided in an openable and closable manner and can have a closed state (FIG. 1) and an open state (FIGS. 2 to 5). When the cover unit 21 is opened, a placement unit 23 and a medium accommodation unit 20 are exposed to the inside of a pull-out opening 2a, as illustrated in FIGS. 2 and 3. The medium that has been recorded and discharged is placed on the placement unit 23, and the medium accommodation unit 20 accommodates the medium to be fed. The term “medium accommodation unit” may be rephrased as a paper feed cassette, a paper tray, or the like.

The cover unit 21 is provided to be rotatable with respect to an end portion in the +Y direction of the medium accommodation unit 20.

The medium accommodation unit 20 includes a stacking unit 20a on which the medium is stacked, and the cover unit 21 that is provided at the end portion in the +Y direction of the medium accommodation unit 20. The +Y direction is a pull-out direction of the medium accommodation unit 20. Further, instead of a wall, an opening 20b is formed at an end portion in the +Y direction of the stacking unit 20a. Therefore, in addition to storing the medium from above the medium accommodation unit 20, the user can insert the medium in the −Y direction through the opening 20b. Note that it goes without saying that the opening 20b need not necessarily be formed and a wall may be provided at the end portion in the +Y direction of the stacking unit 20a.

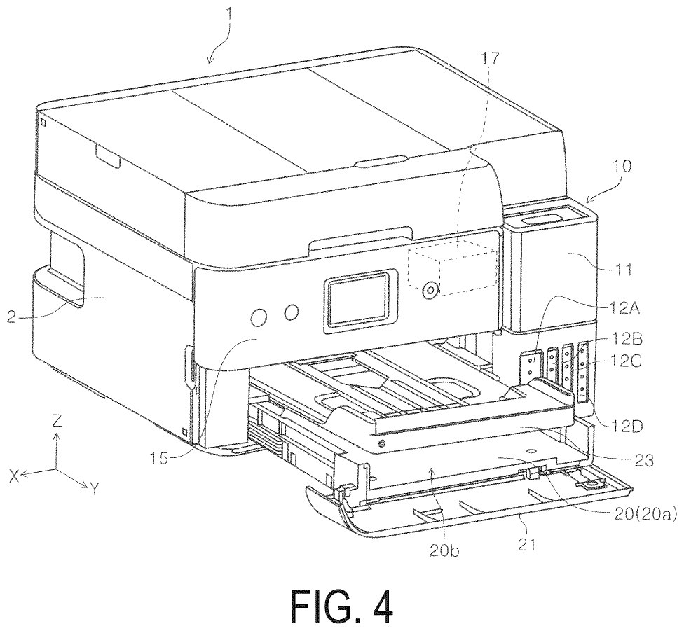

The medium accommodation unit 20 is displaceable in the Y-axis direction by a manual operation of the user, and can have an accommodated state (FIGS. 2 and 3) in which the medium accommodation unit 20 is accommodated in the device main body 2 and a pulled-out state (FIG. 4) in which the medium accommodation unit 20 is pulled out from the device main body 2. Note that the medium accommodation unit 20 according to this embodiment is not removable from the device main body 2, and movement of the medium accommodation unit 20 in the +Y direction beyond the pulled-out state is regulated by a regulating unit (not illustrated).

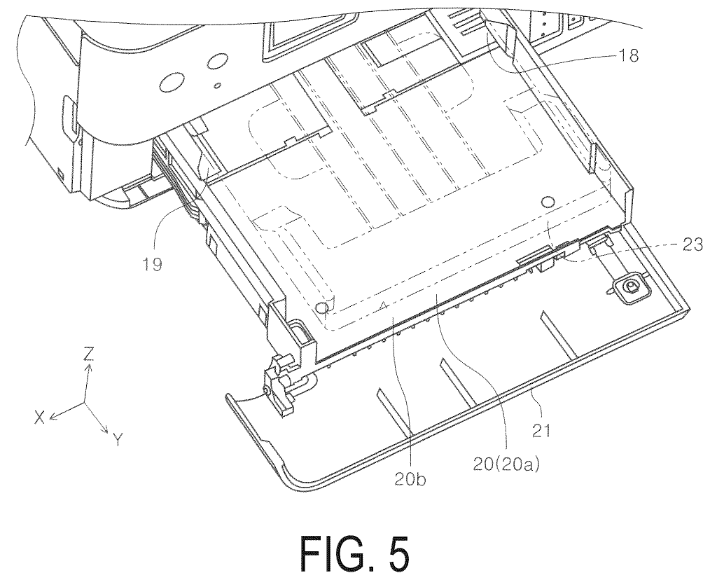

The medium accommodation unit 20 includes an edge guide 18 (see FIG. 5) that regulates a side end in the −X direction of the accommodated medium and an edge guide 19 (see FIG. 5) that regulates a side end in the +X direction of the accommodated medium.

The edge guides 18 and 19 are displaced in a direction in which both come closer to each other or in a direction in which both are separated away from each other by a rack and pinion mechanism (not illustrated).

The placement unit 23 is displaceable in the Y-axis direction by a driving force of a motor (not illustrated) and can have a protruding state (FIGS. 3 and 4) in which the placement unit 23 protrudes from the device main body 2 and a retracted state (FIG. 2) in which the placement unit 23 is retracted from the protruding state. The term “placement unit” may be rephrased as a paper discharge tray, a paper discharge stacker, or the like.

The printer 1 includes a detection unit that detects the position of the placement unit 23, and when the placement unit 23 is in the retracted state at a time of performing recording, a control unit (not illustrated) of the printer 1 switches the placement unit 23 to the protruding state. Further, the user can switch the state of the placement unit 23 via a user interface (not illustrated) of the operation panel 15.

Further, a friction clutch (not illustrated) is provided at a power transmission mechanism disposed between the motor (not illustrated) that drives the placement unit 23 and the placement unit 23, and the user can also displace the placement unit 23 by applying an external force to the placement unit 23.

Note that the placement unit 23 need not necessarily be configured to be driven by a power source, and may be configured to be displaced only by a manual operation of the user.

However, in a configuration in which the placement unit 23 is power driven to be displaced between the protruding state and the retracted state, the placement unit 23 automatically enters the protruding state when the medium is discharged, and it is thus possible to prevent the user from forgetting to perform the operation.

The placement unit 23 is located above the medium accommodation unit 20 and covers the medium accommodation unit 20. Specifically, as illustrated in FIG. 2, when the medium accommodation unit 20 is in the accommodated state and the placement unit 23 is in the retracted state, the placement unit 23 covers the medium accommodation unit 20.

Further, as illustrated in FIG. 3, when the medium accommodation unit 20 is in the accommodated state and the placement unit 23 is in the protruding state, the placement unit 23 covers the medium accommodation unit 20.

Further, as illustrated in FIG. 4, when the medium accommodation unit 20 is in the pulled-out state and the placement unit 23 is in the protruding state, the placement unit 23 covers the medium accommodation unit 20.

Therefore, the placement unit 23 does not cover the medium accommodation unit 20 when the medium accommodation unit 20 is in the pulled-out state and the placement unit 23 is in the retracted state. This state is a state in which the placement unit 23 indicated by the two dot chain line in FIG. 5 is not present.

Note that, in this embodiment, in the state illustrated in FIG. 2, the front end of the medium accommodation unit 20 in the +Y direction and the front end of the placement unit 23 in the +Y direction are aligned with each other.

Note that the placement unit 23 may be completely accommodated in the device main body 2 in the retracted state, or a portion of the placement unit 23 may protrude from the device main body 2 even in the retracted state. In other words, it is sufficient that the placement unit 23 is located further in the −Y direction in the retracted state than in the protruding state.

Further, the medium accommodation unit 20 may be completely accommodated in the device main body 2 in the accommodated state, or a portion of the medium accommodation unit 20 may protrude from the device main body 2 even in the accommodated state. In other words, it is sufficient that the medium accommodation unit 20 is located further in the −Y direction in the accommodated state than in the pulled-out state.

At the front surface of the device main body 2, a liquid storage unit 10 is provided on the −X direction side, that is, on the right side. As an example, the liquid storage unit 10 stores black, yellow, magenta, and cyan inks.

In a configuration in which the liquid storage unit 10 includes a cover member 11, which is provided in an openable and closable manner, when the cover member 11 is opened, an ink supplying port (not illustrated) is exposed and ink can be replenished from the ink supplying port.

At the front surface of the liquid storage unit 10, remaining amount viewing units 12A, 12B, 12C, and 12D for making the remaining amounts of ink visible are provided for respective colors of the ink. Note that when it is not necessary to distinguish the remaining amount viewing units 12A, 12B, 12C, and 12D, they are collectively referred to as remaining amount viewing units 12.

Hereinafter, the placement unit 23 will be described in detail.

For example, during execution of a recording job, when the medium in the medium accommodation unit 20 runs out, the control unit (not illustrated) of the printer 1 displays an alert indicating that the medium has run out, on the operation panel 15 or a display of an external computer (not illustrated) connected to the printer 1. In response to this, the user pulls out the medium accommodation unit 20 to the pulled-out state and replenishes the medium.

FIG. 4 illustrates an example of the state at this time. Since the placement unit 23 covers the medium accommodation unit 20 in this state, it is normally preferable to set the placement unit 23 in the retracted state. However, some users may insert the medium into the medium accommodation unit 20 in the state illustrated in FIG. 4. At this time, if the medium accommodation unit 20 is not visible, it becomes difficult to insert the medium into the medium accommodation unit 20. Further, when the medium is inserted into the medium accommodation unit 20, the medium may be caught by the edge guides 18 and 19 (see FIG. 5) and it may be difficult to accommodate the medium.

Therefore, the placement unit 23 is formed of a light-transmissive material such that at least a portion of the medium accommodation unit 20 is visible. As the light-transmissive material, a resin material such as a vinyl chloride resin, a polyethylene terephthalate (PET) resin, an acrylic resin, or a polycarbonate (PC) resin can be employed. The placement unit 23 may be translucent or colored as long as at least a portion of the medium accommodation unit 20 is visible. Further, a part or the whole of the surface of the placement unit 23 may be mirror-finished. Further, a part or the whole of the surface of the placement unit 23 may be subjected to emboss processing.

As an example, the transmittance of the placement unit 23 is preferably 80% or more, and is more preferably 90% or more. However, since the visibility of the placement unit 23 changes depending on the color of the placement unit 23 or the surface processing applied thereto, the transmittance is not limited to the above-described values.

With such a placement unit 23, even if the medium accommodation unit 20 is covered by the placement unit 23, it becomes easier to accommodate the medium in the medium accommodation unit 20.

Note that although the whole of the placement unit 23 transmits light in this embodiment, only a portion of the placement unit 23 may transmit light. Further, of a portion of the medium accommodation unit 20 that is visible from the outside, the whole or a part of the portion may be visible.

Further, in this embodiment, when viewed in a direction intersecting a placement surface of the placement unit 23, specifically, in the Z-axis direction, at least a portion of the placement unit 23 in the protruding state overlaps the medium accommodation unit 20 in the pulled-out state, and the overlapping portion transmits light.

In FIG. 5, although the placement unit 23 is in the protruding state, the placement unit 23 is illustrated by the two dot chain line in order to indicate that the medium accommodation unit 20 is visible. A portion of the placement unit 23 indicated by the two dot chain line in FIG. 5 is a portion entirely overlapping the medium accommodation unit 20 in the pulled-out state, and this portion transmits light in this embodiment.

In a configuration in which the placement unit 23 in the protruding state overlaps the medium accommodation unit 20 in the pulled-out state, when the medium is accommodated in the medium accommodation unit 20, the medium accommodation unit 20 is not visible due to the placement unit 23, and it may be difficult to accommodate the medium in the medium accommodation unit 20.

However, when at least a portion of the placement unit 23 in the protruding state overlaps the medium accommodation unit 20 in the pulled-out state, the overlapping portion transmits light. Therefore, it becomes easier to accommodate the medium in the medium accommodation unit 20.

Note that the whole of the overlapping portion need not necessarily transmit light, and also, a portion other than the overlapping portion may transmit light. As an example, in this embodiment, the whole of the placement unit 23 transmits light.

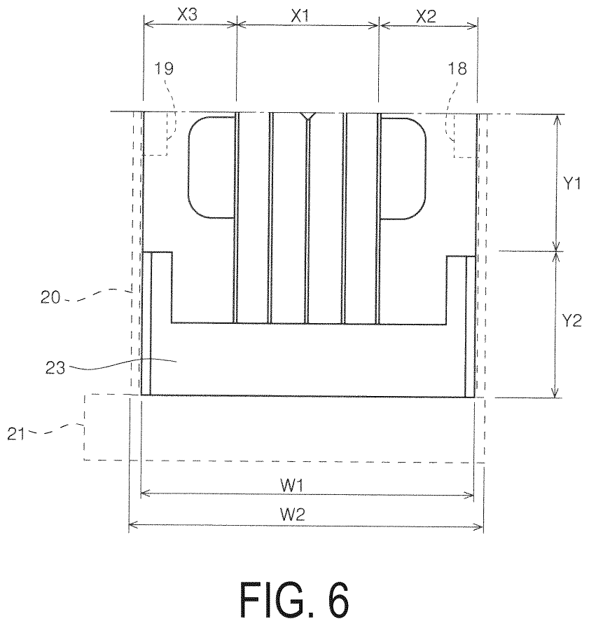

Further, the medium accommodation unit 20 includes the edge guides 18 and 19 that are regulating units that regulate the end portions of the medium. When viewed in the direction intersecting the placement surface of the placement unit 23, specifically, in the Z-axis direction, portions of the placement unit 23 in the protruding state, respectively overlapping the edge guides 18 and 19 of the medium accommodation unit 20 in the pulled-out state, transmit light. Examples of such an overlapping portion include a region defined by a range Y1 and a range X2, and a region defined by the range Y1 and a range X3 in FIG. 6.

Here, a range X1 is a region in which a medium having the smallest size in the X-axis direction is placed with respect to the X-axis direction. Further, the range X2 is a region outside the range X1 and is a region in which the edge guide 18 is displaced. Further, the range X3 is a region outside the range X1 and is a region in which the edge guide 19 is displaced. Accordingly, even when the placement unit 23 is in the protruding state, the edge guides 18 and 19 are visible through the placement unit 23. Therefore, when the medium is accommodated in the medium accommodation unit 20, the medium is unlikely to be caught by the edge guides 18 and 19, and it becomes easier to accommodate the medium.

Even in such a configuration, the whole of the overlapping portion need not necessarily transmit light, and also, a portion other than the overlapping portion may transmit light. As an example, in this embodiment, the whole of the placement unit 23 transmits light.

Further, the edge guides 18 and 19 guide the side ends of the medium in a width direction, but an edge guide (not illustrated) that guides the rear end of the medium in a feeding direction may also be visible.

Further, the placement unit 23 may transmit light through the whole of movement regions of the edge guides, or may transmit light only through portions of the movement regions corresponding to a mainly used size of the medium, for example, portions of the movement regions corresponding to a standard size of the medium. Further, in a configuration in which displacement of one of the edge guides 18 and 19 is interlocked with displacement of the other, light may be transmitted through only a region corresponding to the one of the edge guides 18 and 19.

However, as in this embodiment, according to the configuration in which the whole of the placement unit 23 transmits light, a wide range of the medium accommodation unit 20 becomes easily visible through the placement unit 23.

Further, in this embodiment, as illustrated in FIG. 4, the remaining amount viewing units 12 for making the remaining amounts of inks visible overlap the placement unit 23 in a device height direction. In such a configuration, the placement unit 23 may overlap the remaining amount viewing units 12 and may obstruct viewing of the remaining amount viewing units 12. However, since the placement unit 23 transmits light, the remaining amount viewing units 12 can be viewed through the placement unit 23.

Further, the device main body 2 is formed with the pull-out port 2a through which the medium accommodation unit 20 can be pulled out. The medium accommodation unit 20 includes the stacking unit 20a on which the medium is stacked and in which the opening 20b is formed in a pull-out direction of the medium accommodation unit 20 from the device main body 2. Further, the medium accommodation unit 20 includes the cover unit 21 that is displaced between a closed state in which the cover unit 21 closes the pull-out port 2a and the opening 20b in a posture intersecting the stacking unit 20a, and an open state in which the cover unit 21 opens the pull-out port 2a and the opening 20b. In such a configuration, when the cover unit 21 is open, some users may attempt to accommodate the medium from the opening 20b of the stacking unit 20a in a state in which the placement unit 23 is in the protruding state. At this time, the medium accommodation unit 20 may not be visible due to the placement unit 23 and it may be difficult to accommodate the medium in the medium accommodation unit 20. However, as described above, since the placement unit 23 transmits light, it becomes easier to accommodate the medium in the medium accommodation unit 20.

Note that, in this embodiment, as illustrated in FIG. 6, a size W1 of the placement unit 23 is smaller than a size W2 of the medium accommodation unit 20 in the width direction which is a direction intersecting the Y-axis direction, which is a displacement direction of the medium accommodation unit 20 and the placement unit 23.

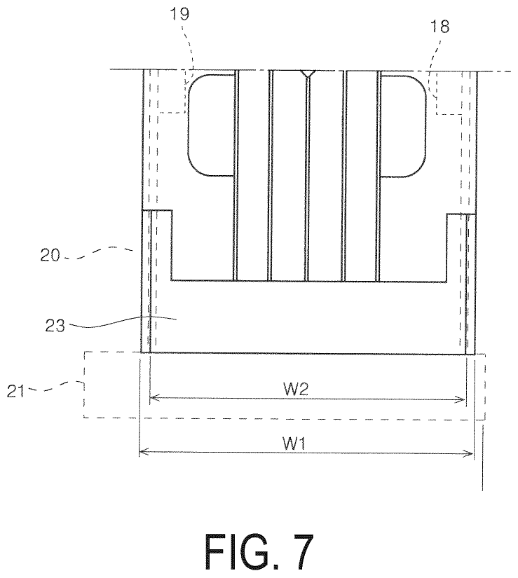

However, as illustrated in a modified example of FIG. 7, the size W1 of the placement unit 23 may be larger than the size W2 of the medium accommodation unit 20. In such a configuration, the medium accommodation unit 20 becomes even less visible due to the placement unit 23. However, as described above, since the placement unit 23 transmits light, it becomes easier to accommodate the medium in the medium accommodation unit 20.

Further, in this embodiment, in the Y-axis direction which is the displacement direction of the medium accommodation unit 20 and the placement unit 23, as described above with reference to FIG. 2, the front end of the placement unit 23 in the retracted state is aligned with the front end of the medium accommodation unit 20 in the accommodated state. Accordingly, the placement unit 23 can suppress dust or the like from entering the interior of the medium accommodation unit 20. On the other hand, the medium accommodation unit 20 is hidden by the placement unit 23. However, since the placement unit 23 transmits light as described above, it becomes easier to accommodate the medium in the medium accommodation unit 20.

In the placement unit 23 of related art, in order to enhance the visibility of the medium placed on the placement unit 23, the color of the placement unit 23 is set to a deep color or a dark color such as black in order to enhance the contrast between the color of the medium and the color of the placement unit 23. On the other hand, the placement unit 23 according to this embodiment transmits light. Thus, the medium is easily visible even if the color of the placement unit 23 is not deepened or darkened. Therefore, the color of the placement unit 23 can be set to a light color or a bright color. Thus, it is possible to reduce restrictions on the color of the placement unit 23, and the color of the placement unit 23 can also be used to make the medium accommodation unit 20 easily visible.

The present disclosure is not limited to the embodiments and modifications described above, and it is obvious that various modifications are possible within the scope of the disclosure described in the claims, and these are also included in the scope of the present disclosure.

What is claimed is:

1. A recording device comprising:
a recording unit configured to perform recording on a medium;
a device main body configured to accommodate the recording unit;
a medium accommodation unit configured to accommodate the medium to be recorded by the recording unit; and
a placement unit covering at least a portion of the medium accommodation unit from above the medium accommodation unit and on which the medium recorded by the recording unit is placed, wherein
the medium accommodation unit is displaceable between a pulled-out state in which the medium accommodation unit is pulled out from the device main body and an accommodated state in which the medium accommodation unit is accommodated in the device main body, and is not removable from the device main body,
the placement unit is displaceable between a protruding state in which the placement unit protrudes from the device main body and a retracted state in which the placement unit is retracted from the protruding state, and
at least a portion of the placement unit transmits light to cause at least a portion of the medium accommodation unit to be visible.

2. The recording device according to claim 1, wherein
when viewed in a direction intersecting a placement surface of the placement unit, at least a portion of the placement unit in the protruding state overlaps the medium accommodation unit in the pulled-out state, and an overlapping portion transmits light.

3. The recording device according to claim 1, wherein
the medium accommodation unit includes a regulating unit configured to regulate an end portion of the medium, and
when viewed in a direction intersecting a placement surface of the placement unit, a portion, of the placement unit in the protruding state, overlapping the regulating unit of the medium accommodation unit in the pulled-out state transmits light.

4. The recording device according to claim 1, wherein
a whole of the placement unit transmits light.

5. The recording device according to claim 4, wherein
the recording unit performs recording by ejecting a liquid onto the medium,
the device main body includes
a liquid storage unit configured to store the liquid to be ejected by the recording unit, and
a viewing unit configured to make visible a remaining amount of the liquid in the liquid storage unit, and
the viewing unit overlaps the placement unit in a device height direction.

6. The recording device according to claim 1, wherein
the device main body is formed with a pull-out port through which the medium accommodation unit is pulled out, and
the medium accommodation unit includes
a stacking unit on which the medium is stacked, the stacking unit having an opening in a pull-out direction of the medium accommodation unit from the device main body, and
a cover unit provided at one end of the stacking unit in the pull-out direction and configured to be displaceable between a closed state, in which the cover unit closes the pull-out port and the opening in a posture intersecting the stacking unit, and an open state, in which the cover unit opens the pull-out port and the opening.

7. The recording device according to claim 1, wherein
in a width direction that is a direction intersecting a displacement direction of the medium accommodation unit and the placement unit, a dimension of the placement unit is larger than a dimension of the medium accommodation unit.

8. The recording device according to claim 1, wherein
in a displacement direction of the medium accommodation unit and the placement unit, a front end of the placement unit in the retracted state is aligned with a front end of the medium accommodation unit in the accommodated state.

9. The recording device according to claim 1, wherein
the placement unit is power driven to be displaced between the protruding state and the retracted state using power.
